(19) United States
(12) Patent Application Publication
(10) Pub. No.: US 2020/0239180 A1
(43) Pub. Date: Jul. 30, 2020

(54) PACKAGING

(71) Applicant: Mars, Incorporated, McLean, VA (US)

(72) Inventors: Olly SIMPSON, Bristol (GB); Alex MARGETTS, Reading (GB)

(73) Assignee: Mars, Incorporated, McLean, VA (US)

(21) Appl. No.: 16/633,856

(22) PCT Filed: Aug. 3, 2018
(86) PCT No.: PCT/GB2018/052232

§ 371 Date: Jan. 24, 2020

(30) Foreign Application Priority Data
Aug. 3, 2017 (GB) 1712506.3

(51) Int. Cl. B65D 5/20; B65D 5/32; B65D 5/46; B65D 5/54; B31B 50/26

(52) U.S. Cl. CPC B65D 5/2057; B65D 5/321; B31B 50/26; B65D 5/541; B65D 5/46016

(57) ABSTRACT

There is disclosed packaging comprising a base, a pair of first flaps located on opposing sides of the base and arranged to be folded over the base and secured together so as to define an packaging enclosure, and a pair of second flaps located on opposing sides of the base and arranged to be folded over the pair of first flaps and secured together so as to form a cruciform configuration with the pair of first flaps. First and second opening features are provided which are independently operable in use to respectively separate the pair of first flaps from one another and the pair of second flaps from one another so as to open the packaging.

The invention relates to packaging comprising a base and a pair of first flaps arranged to be folded over the base to define a packaging enclosure and a pair of second flaps arranged to be folded over the first pair of flaps. More particularly, but not exclusively, the invention relates to packaging for loose products such as a bag of kibbles (dry food pellets).

It is increasingly common for people to purchase products online and have them delivered to their home or business using a delivery or shipping company. For example, people regularly purchase food, drink, and consumer products online and have them delivered/shipped using a courier or the like. It is important that the purchased product is adequately packaged so that it is not damaged during transportation. Therefore, various different types of packaging and packaging accessories are known which aim to protect products during transportation.

If the products to be transported are loose, it may be important to secure them to prevent them moving around during transportation. For example, if the product to be transported is a bag of dry compound pet feed (sometimes referred to as kibbles), it may be important to ensure that the kibbles are securely held to prevent movement during transportation. If the kibbles are not adequately protected during transportation, the kibbles may become damaged and turn at least partly to powder which may make them unusable.

It may therefore be desirable to provide improved packaging which may alleviate some of these problems to at least some extent.

According to an aspect there is provided packaging comprising: a base; a pair of first flaps located on opposing sides of the base and arranged to be folded over the base and secured together so as to define a packaging enclosure; a pair of second flaps located on opposing sides of the base and arranged to be folded over the pair of first flaps and secured together so as to form a cruciform configuration with the pair of first flaps; and first and second opening features independently operable in use to respectively separate the pair of first flaps from one another and the pair of second flaps from one another so as to open the packaging. When assembled, the pair of first flaps can be secured tightly over the product(s) within the packaging enclosure and the pair of second flaps can be secured tightly over the pair of flaps and the packaging enclosure so as to securely hold the product(s) within the packaging enclosure. In order to open the packaging the pair of second flaps are separated from one another utilising the second opening feature, and then the pair of first flaps are separated from one another utilising the first opening feature. The packaging enclosure may have a variable volume which is dependent on the amount of overlap of the pair of first flaps.

The pair of first flaps may be arranged to overlap. The degree of overlap may be variable. The pair of first flaps may be arranged to be bonded to one another. The first pair of flaps may be arranged to be bonded to one another using an adhesive. The pair of second flaps may be arranged to overlap. The degree of overlap may be variable. The pair of second flaps may be arranged to be bonded to one another. The second pair of flaps may be arranged to be bonded to one another using an adhesive.

The pair of first flaps may be arranged not to be secured to the pair of second flaps. In other words, the pair of second flaps may not be bonded to the pair of first flaps. Therefore, in order to open the packaging it is not necessary to separate the second flaps from the first flaps.

The base may comprise a pair of first sides that are substantially parallel to one another, and a pair of second sides that are substantially parallel to one another and substantially perpendicular to the pair of first sides. Each first flap may extend from a respective first side. Each second flap may extend from a respective second side.

The width of the pair of second flaps may be greater than the depth of the packaging enclosure defined by the pair of first flaps. The second flaps may have the same width as each other or they may have different widths. The edges of the pair of second flaps may be reinforced. The edges of the pair of second flaps may be reinforced by a folded portion.

At least one of or both of the first flaps may comprise a chamfered portion formed by first and second folds along the width of the respective flap. At least one of or both of the second flaps may comprise a chamfered portion formed by first and second folds along the width of the flap. At least one of or both of the first flaps may comprise a side region. At least one of or both of the second flaps may comprise a side region. A chamfered portion may be provided either side of the or each side region.

The first opening feature may be configured to tear a portion of at least one first flap. The first opening feature may comprise a tear strip. The second opening feature may be configured to tear a portion of at least one second flap. The second opening feature may comprise a tear strip. The or each tear strip may be defined by one or more weakened lines provided in the respective flap. The weakened lines may be perforations, for example. The tear strip may comprise a tear tape provided underneath the respective flap and arranged to be pulled through the flap. In use, access to the first opening feature may be inhibited by the pair of second flaps. In use, the pair of second flaps may cover the first opening feature.

The packaging may be formed from one or more blanks. The blanks may be cardboard blanks which may or may not be corrugated.

The packaging may comprise a first blank (or first component or inner component) comprising the pair of first flaps and a separate second blank (or second component of inner component) comprising the pair of second flaps. The first blank and the second blank may be secured or may be arranged to be secured together. The first and second blanks may be bonded together. The first blank may be secured to an inner side of the second blank. The first and second blanks may be arranged in a cruciform configuration. Using separate blanks may allow easy customisation by printing.

At least one of the first flaps may be provided with first and second side tabs which extend from opposing sides of the first flap. The first and second side tabs may be arranged to be folded inwards and retained by the pair of second flaps. Each first flap may comprise first and second side tabs.

The packaging may further comprise a carry handle in the form of a strap, such as a strap of material or fabric. A first end of the strap may be arranged to be secured to a first side tab. A second end of the strap may be arranged to be secured to a second side tab. The first and second ends of the strap may be arranged to be secured to an inner surface of the first and second side tabs respectively.

The packaging may be for loose product, such as kibbles. The loose product, such as kibbles, may be provided within a bag which is arranged to be located within the packaging enclosure. The term “kibbles” may be understood to mean small pellets or pieces of dry food, such as pet food.

According to another aspect there is provided assembled packaging comprising the packaging in accordance with any statement herein wherein the pair of first flaps are folded over the base and secured together so as to define an packaging enclosure; and wherein the pair of second flaps are folded over the pair of first flaps and secured together so as to form a cruciform configuration with the pair of first flaps.

According to a further aspect there is provided a packaged product comprising assembled packaging in accordance with any statement herein; and one or more products held within the packaging enclosure. A bag of loose product, such as kibbles, may be held within the packaging enclosure.

The invention also relates to one or more blanks for forming at least a part of the packaging in accordance with any statement herein.

The invention may comprise any combination of the features and/or limitations referred to herein, except combinations of such features as are mutually exclusive.

Embodiments of the invention will now be described, by way of example, with reference to the accompanying drawings, in which:

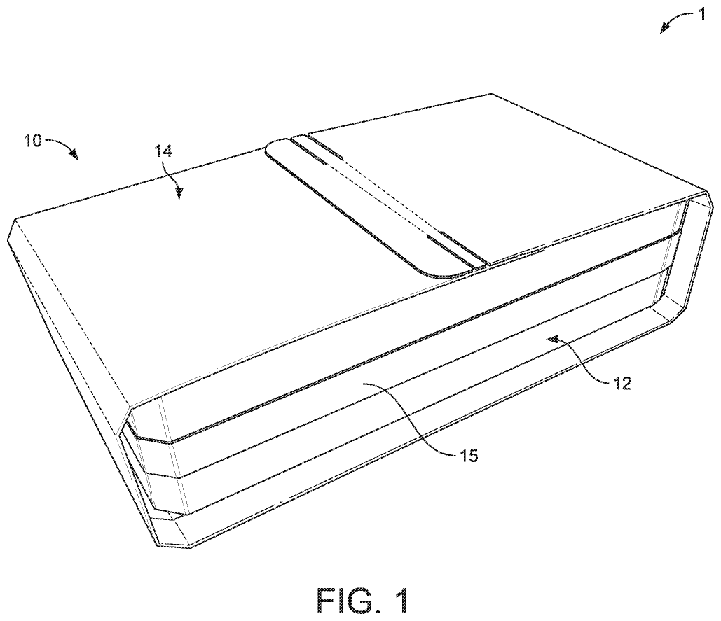

FIG. 1 schematically shows a perspective view of a packaged product;

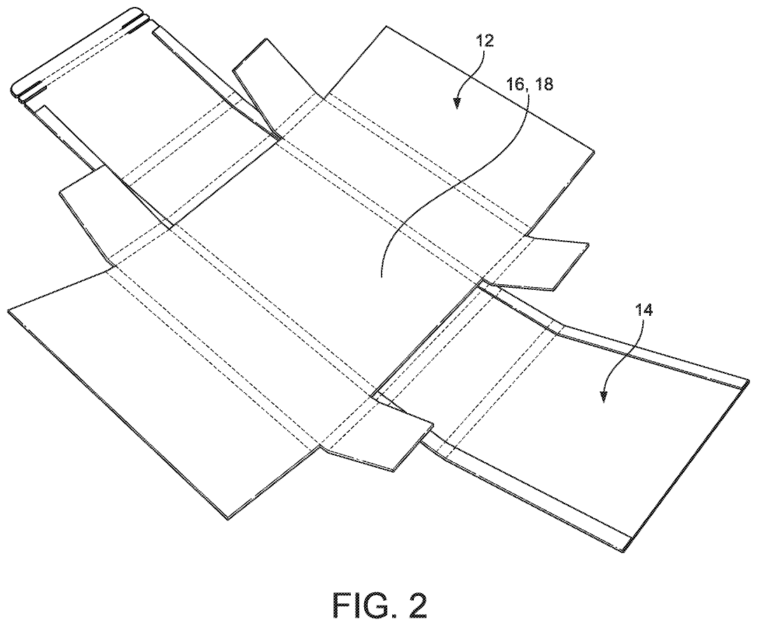

FIG. 2 schematically shows the packaging (before assembly) of FIG. 1;

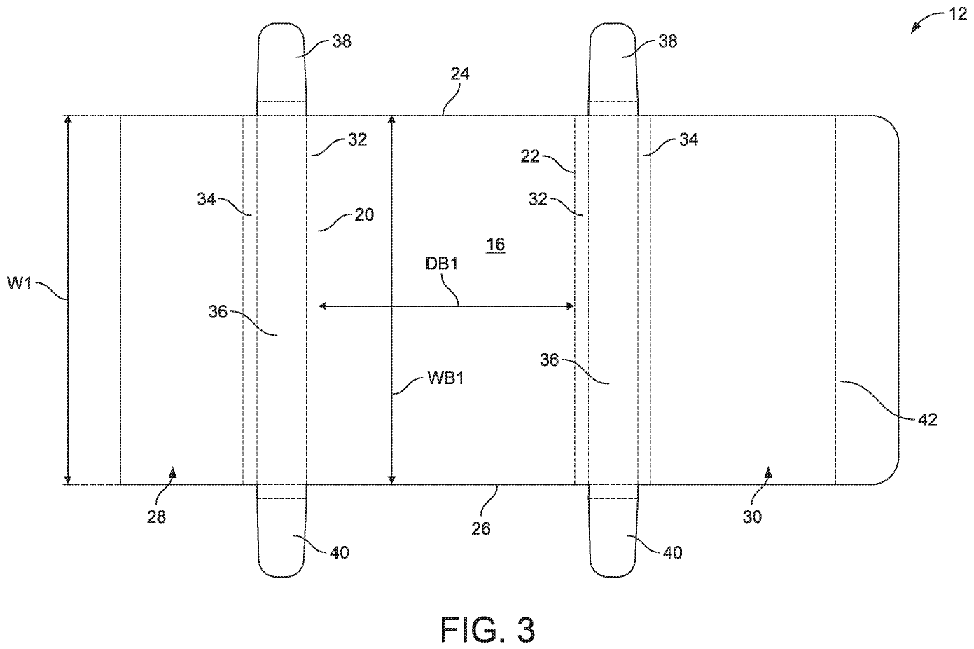

FIG. 3 schematically shows the inner component of the packaging of FIG. 2;

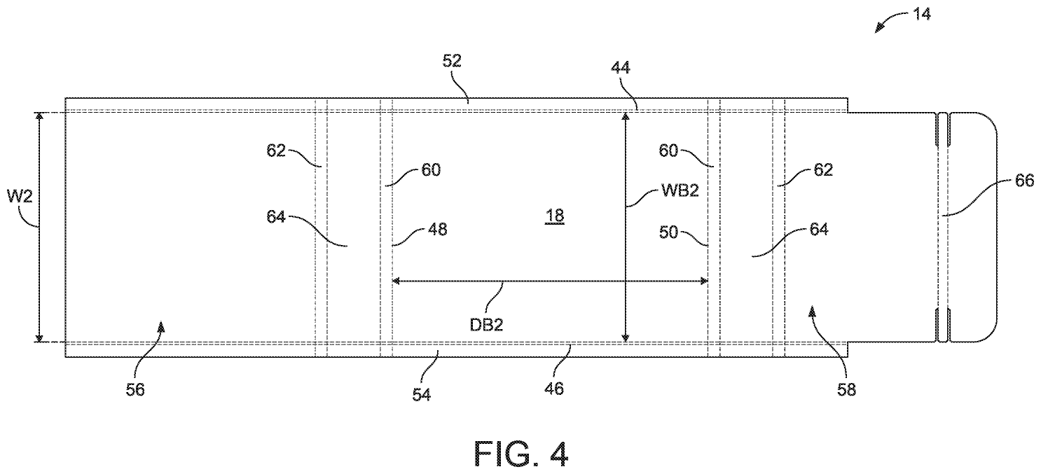

FIG. 4 schematically shows the outer component of the packaging of FIG. 2;

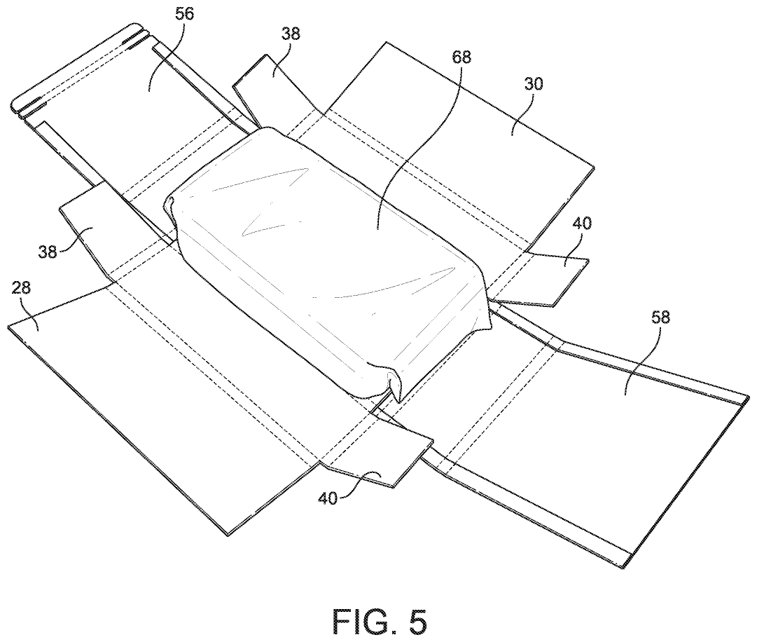

FIG. 5 schematically shows the packaging of FIG. 2 with a bag of loose product placed on the base;

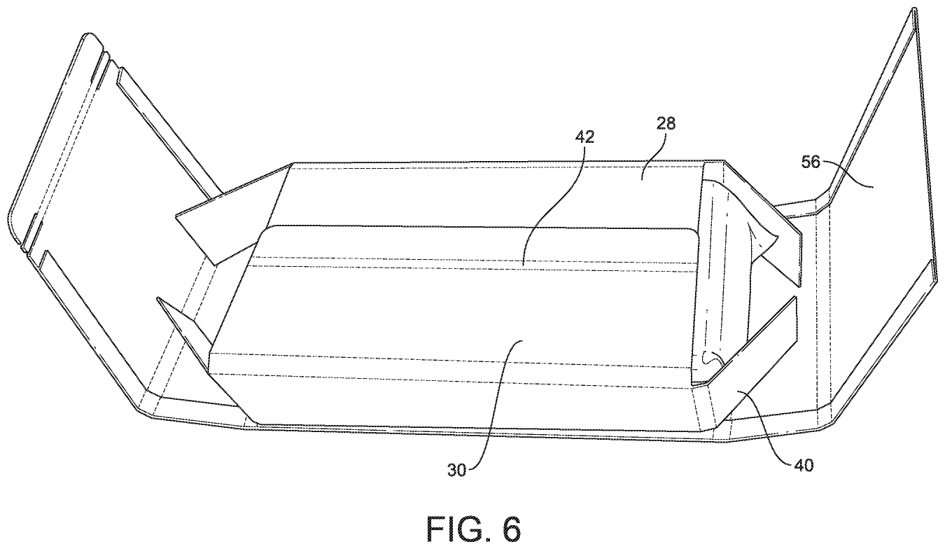

FIG. 6 schematically shows the packaging partially assembled; and

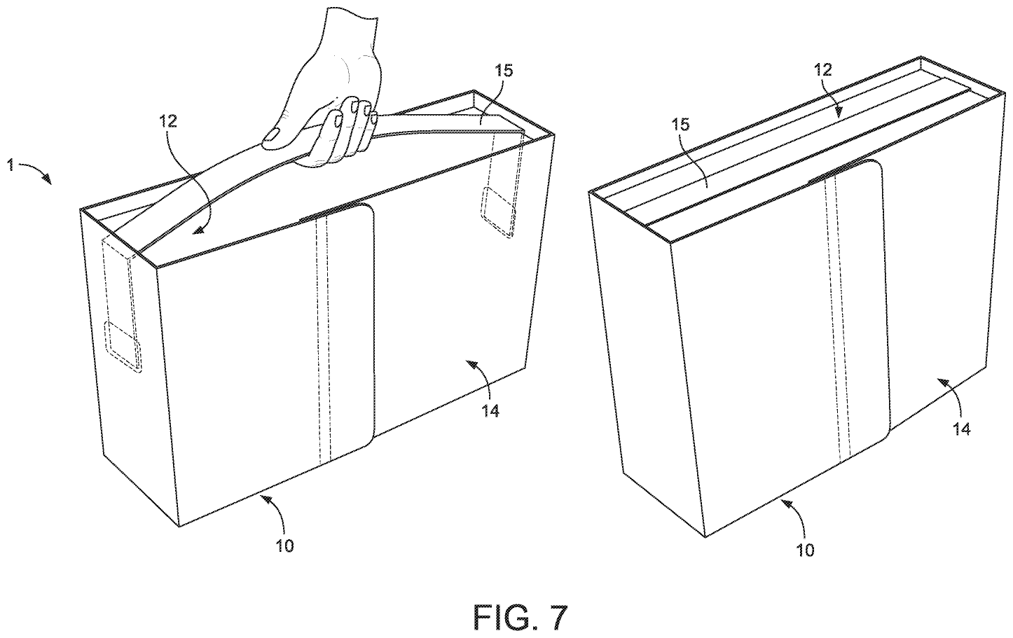

FIG. 7 schematically shows two views of the packaged product.

FIG. 1 shows a packaged product 1 comprising product (not shown in FIG. 1) securely held within a packaging enclosure defined by assembled packaging 10. The packaging 10 may be configured to securely hold loose product, for example a bag of kibbles, so that during transportation the product is not damaged. This may be particularly beneficial when transporting kibbles as if the kibbles are not held securely they may become damaged and crushed and partially turn into powder. The term “kibbles” may be understood to mean dry food pellets or the like, such as dry animal feed. The packaging 10 generally comprises an inner component 12 comprising a pair of first flaps that are folded over and secured together to define a packaging enclosure which securely holds the product, and an outer component 14 comprising a pair of second flaps that are folded over the first inner component 12 and secured together. A carry handle 15 in the form of a strap is also provided to enable the packaged product 1 to be easily transported.

Referring now to FIG. 2, the inner and outer components 12, 14 are formed from separate cardboard blanks that are secured together. The inner and outer components 12, 14 are arranged in a cruciform configuration (i.e. they are at right angles to one another) with an outer surface of a base region 16 of the inner component 12 bonded (i.e. glued) to an inner surface of a base region 18 the outer component 14. The inner and outer components 12, 14 are bonded together in the region in which they overlap. The area of overlap 16, 18 defines a base of the packaging onto which the product(s) to be packaged can be placed. Although it has been described that the packaging is formed from separate inner and outer components 12, 14, the packaging could be formed from a single component.

As shown in FIG. 3, the inner component 12 comprises the base region 16 having a pair of first sides 20, 22 and a pair of second sides 24, 26. The first sides 20, 22 are located on opposing sides of the base 16 and are generally parallel to one another. The second sides 24, 26 are located on opposing sides of the base 16 and are generally parallel to one another and perpendicular to the first sides 20, 22. Accordingly, the base region 16 is generally rectangular and has a width WB1 in a direction parallel to the direction of extent of the first sides 20, 22 and a depth DB1 in a direction parallel to the direction of extent of the second sides 24, 26. The width WB1 and depth DB1 generally define the size of the packaging enclosure (in plan). The inner component also comprises a pair of first flaps 28, 30 which are located on opposing sides of the base region 16 and which extend from the first sides 20, 22. The first flaps 28, 30 have a width W1, in a direction perpendicular to the direction of extent of the flaps, that is the substantially the same as the width WB1 of the base. Each of the first flaps 28, 30 comprises two chamfered portions 32, 34 that are each defined by first and second fold lines that extend across the width of the flap 28, 30. The two chamfered portions 32, 34 are spaced apart so as to form a side region 36 which substantially defines the height of the packaging enclosure in use. Each first flap 28, 30 also comprises first and second side tabs 38, 40. The first and second side tabs 38, 40 extend from opposing sides of the side region 36 of the first flap 28, 30 in a direction parallel to the width direction of the first component 12. As will be described in detail below, the first and second side tabs 38, 40 are arranged to be folded inwards when the packaging is assembled. One of the first flaps 30 also comprises an opening feature 42 in the form of a tear strip that extends across the entire width of the first flap 30. The tear strip 42 is defined by two perforated lines such that the tear strip 42 can be torn away from the remainder of the flap 30.

As shown in FIG. 4, the outer component 14 comprises the base region 18 having a pair of first sides 44, 46 and a pair of second sides 48, 50. The first sides 44, 46 are located on opposing sides of the base 18 and are generally parallel to one another. The second sides 48, 50 are located on opposing sides of the base 18 and are generally parallel to one another and perpendicular to the first sides 44, 46. Accordingly, the base region 18 is generally rectangular. The sides of the outer component 14 (the sides parallel to the first pair of sides 44, 46) are provided with reinforcement portions 52, 54 that extend along the majority of the length of the outer component 14. These are arranged to be folded inwards by 180 degrees and bonded onto the remainder of the outer component so as to reinforce the sides of the outer component 14. The base region 18 has a width WB2 in a direction parallel to the direction of extent of the second sides 48, 50 and a depth DB2 in a direction parallel to the direction of extent of the first sides 44, 46. The base region 18 is larger than the base region 16 of the inner component 12 such that the base region 16 of the inner component 12 can be placed on top of and within the limits of the base region 18 of the outer component.

The outer component also comprises a pair of second flaps 56, 58 which are located on opposing sides of the base region 18 and which extend from the second sides 48, 50. The second flaps 56, 58 have a width W2 in a direction perpendicular to the direction of extent of the flaps that is the substantially the same as the width WB2 of the base 18. Each of the second flaps 56, 58 comprises two chamfered portions 60, 62 that are each defined by first and second fold lines that extend across the width of the flap 56, 58. The two chamfered portions 60, 62 are spaced apart so as to form a side region 64 which substantially defines the height of the packaging in use. One of the second flaps 58 also comprises an opening feature 66 in the form of a tear strip that extends across the entire width of the second flap 58. The tear strip 66 is defined by two perforated lines such that the tear strip 66 can be torn away from the remainder of the flap 58. In this arrangement, the width W2 of the second flaps 56, 58 is larger than the depth DB1 of the packaging enclosure defined by the inner component 12 such that the reinforced edges of the outer component 14 protect the inner component 12 when the packaging is assembled.

Referring back to FIG. 2, the packaging 10 is initially assembled by arranging the inner and outer components 12, 14 in a cruciform configuration such that the pair of first flaps 28, 28 extend in a direction perpendicular to the direction of extent of the pair of second flaps 56, 58. The lower surface of the base region 16 of the inner component 12 is bonded to the upper surface of the base region 18 of the outer component 14 so that the two components 12, 14 are secured together.

FIG. 5 shows a large bag of kibbles 68 (dry pet food) located on the base region 16 of the inner component 12. If the kibbles 68 are not held securely during transportation they may become damaged and unusable. The dimensions of the packaging 10 is chosen such that the base region 16 is of a similar size to the footprint of the bag of kibbles 68. In order to securely package the bag of kibbles 68, the first flaps 28, 30 are folded tightly over the bag 68 such that the first flaps 28, 30 overlap (FIG. 6). The flaps 28, 30 are bonded together so as to secure them together. The underside of one flap 30 may be bonded to the upper side of the other flap 28. When the first flaps 28, 30 are folded over the bag 68 they are pulled together tightly so as to securely hold the kibbles in place. The chamfered regions 32, 34 allow the volume of the packaging enclosure defined by the inner component 12 to be changed slightly by changing the degree of overlap of the first flaps 28, 30 so that the packaging enclosure can accommodate bags 68 of slightly different sizes. After the first flaps 28, 30 have been folded over the bag 68, the first and second side tabs 38, 40 are folded inwards by approximately 90 degrees so as to partially cover the open side of the packaging enclosure. The first and second side tabs 38, 40 are “free” and are therefore not bonded or glued to any part of the inner or outer component 12, 14. A carry handle 16 in the form of a strap of fabric material is then attached to one pair of first and second side tabs 38, 40. Specifically, a first end of the strap 15 is attached (such as by gluing) to an inner side of a first tab 38, and a second end of the strap 15 is attached (such as by gluing) to an inner surface of a corresponding second tab 40.

Referring to FIG. 6, the pair of second flaps 56, 58 are folded tightly over the first flaps 28, 30 such that second flaps 56, 58 overlap (FIG. 1). The flaps 56, 58 are bonded together so as to secure them together. The underside of one flap 58 may be bonded to the upper side of the other flap 56. When the second flaps 56, 58 are folded over the first flaps 28, 30 they are pulled together tightly so as to securely hold the kibbles in place. The chamfered regions 60, 62 allow the amount of overlap of the second flaps 56, 58 to be varied so that they can be pulled together as tightly as required in order to hold the bag 68 securely. The second flaps 56, 58 are also folded over the first and second side tabs 38, 40 so as to secure the side tabs 38, 40 in position. In this arrangement, although the first and second flaps 28, 30, 56, 58 overlap, the second flaps 56, 58 are not bonded or secured to the first flaps 28, 30. The pair of second flaps 56, 58 also cover the first opening feature 42 such that access to it is inhibited.

As shown in FIG. 7, in use, the packaged product 1, which may be relatively heavy, can be easily carried by a person by using the carry strap 15. When the packaged product 1 is carried using the carry strap 15, the pair of second flaps 56, 58 retain the first and second side tabs 38, 40 to which the strap 15 is attached and therefore prevents the side tabs 38, 40 from being pulled outwards. During transportation of the packaged product 1, the bag of kibbles 68 (or other product) is securely retained in place by the pair of first flaps 28, 30 and their degree of overlap and the pair of second flaps 56, 58 and their degree of overlap. By increasing the degree of overlap of the flaps, the volume of the packaging enclosure can be altered and therefore the size of the packaging enclosure can be made as small as possible so as to securely retain the product 68. As best shown in FIG. 1, since the width W2 of the second flaps 56, 58 is greater than the depth DB1 of the packaging enclosure, the edges of the second flaps 56, 58 extend beyond the side regions 36 formed by the inner component 12. The extended edges, which are also reinforced by the folded portion 54, therefore protect the inner component 12 and in turn the product 1.

In order to open the packaged product 1 the user must first separate the pair of second flaps 56, 58. This is easily achieved by pulling the tear strip 66 away from the remainder of the respective second flap 58. As the tear strip 66 is pulled, it tears the second flap 58 along two lines which causes the pair of second flaps 56, 58 to be separated from one another. Since the second flaps 56, 58 are not secured to the first flaps 28, 30 once the tear strip 66 has been removed the second flaps 56, 58 can be folded outwards to expose the inner component 12. The first flaps 28, 30 of the first component 12 may be provided with printed information such as text or graphics such that these are presented to the user on folding back the second flaps 56, 58. In order to fully open the packaging the user then separates the pair of first flaps 28, 30. As for the pair of second flaps 56, 58 this is easily achieved by pulling the tear strip 42 away from the remainder of the respective first flap 30. As the tear strip 42 is pulled, it tears the first flap 30 along two lines which causes the pair of first flaps 28, 30 to be separated from one another. Once the pair of second flaps 28, 30 have been separated they can be folded outwards to expose the product (e.g. the bag of kibbles 68) which can then be removed. The packaging can then be recycled by the user.

It has been described that the first and second opening features 42, 66 are in the form of tear strips defined by perforations. However, it should be appreciated that other opening features 42, 66 could be used. For example, the opening features could be in the form of a single perforation or score or other weakened line that can be used to separate the flaps. In another arrangement, a tear tape or thread could be provided underneath the respective flap and pulled through the flap so as to tear through the flap.

The first pair of flaps 28, 30 and the second pair of flaps 56, 58 could be secured together using any suitable method. For example, they could overlap and be bonded to one another using an adhesive. The adhesive could be a pressure sensitive adhesive, a cold melt adhesive or a hot melt adhesive, for example. In one arrangement, strips of pressure sensitive adhesive with a release layer could be provided on the under and/or upper sides of the respective flap. When the product is packaged, the release layer could be peeled away with the flaps then being overlapped and pressed together.

In the arrangement described above the packaging 10 is formed from separate inner and outer 12, 14 components. This may provide manufacturing benefits and/or may allow easy customisation of the packaging. For example, the outer component 14 could be generic, whereas the inner component 12 could be specific to the packaged product, the manufacturer, or the user, for example. Of course, in other arrangements the packaging could be made from a single component or from more than two components.

Although it has been described that the packaging 10 is for securely holding a bag of kibbles (e.g. dry pet food), it could be used for any suitable product or products that needs to be secured during transport or storage.

1. A packaging, comprising:
a base;
a pair of first flaps located on opposing sides of the base and arranged to be folded over the base and secured together so as to define a packaging enclosure;
a pair of second flaps located on opposing sides of the base and arranged to be folded over the pair of first flaps and secured together so as to form a cruciform configuration with the pair of first flaps; and
first and second opening features independently operable in use to respectively separate the pair of first flaps from one another and the pair of second flaps from one another so as to open the packaging.

2. The packaging of claim 1, further comprising a carry handle.

3. The packaging of claim 1, wherein at least one of the first flaps is provided with first and second side tabs which extend from opposing sides of the first flap, wherein the first and second side tabs are arranged to be folded inwards and retained by the pair of second flaps.

4. The packaging of claim 3, wherein each first flap comprises first and second side tabs.

5. The packaging of claim 3, wherein a first end of the strap is arranged to be secured to a first side tab and wherein a second end of the strap is arranged to be secured to a second side tab.

6. The packaging of claim 5, wherein the first and second ends of the strap are arranged to be secured to an inner surface of the first and second side tabs respectively.

7. The packaging of claim 1, wherein the pair of first flaps are arranged to overlap.

8. The packaging of claim 1, wherein the pair of second flaps are arranged to overlap.

9. (canceled)

10. The packaging of claim 1, wherein the base comprises a pair of first sides that are substantially parallel to one another, and a pair of second sides that are substantially parallel to one another and substantially perpendicular to the pair of first sides, wherein each first flap extends from a respective first side and wherein each second flap extends from a respective second side.

11. The packaging of claim 1, wherein the width of the pair of second flaps is greater than the depth of the packaging enclosure defined by the pair of first flaps.

12. (canceled)

13. The packaging of claim 1, wherein the edges of the pair of second flaps are reinforced by a folded portion.

14. The packaging of claim 1, wherein the at least one of the first flaps comprises a chamfered portion formed by first and second folds along the width of the flap.

15. The packaging of claim 1, wherein the at least one of the second flaps comprises a chamfered portion formed by first and second folds along the width of the flap.

16. The packaging of claim 1, wherein the first opening feature is configured to tear a portion of at least one first flap.

17. The packaging of claim 1, wherein the first opening feature comprises a tear strip.

18. The packaging of claim 1, wherein the second opening feature is configured to tear a portion of at least one second flap.

19. The packaging of claim 1, wherein the second opening feature comprises a tear strip.

20. The packaging of claim 1, wherein in use access to the first opening feature is inhibited by the pair of second flaps.

21. (canceled)

22. The packaging of claim 1, comprising a first blank comprising the pair of first flaps and a separate second blank comprising the pair of second flaps, wherein the first blank and the second blank are secured or are arranged to be secured together.

23-27. (canceled)

28. A packaged product, comprising:
a bag of loose kibbles freely positioned on a base;
a pair of first flaps located on opposing sides of the base and folded over the bag of loose kibbles, wherein the pair of first flaps overlap and are bonded to one another;
a pair of second flaps located on opposing sides of the base and folded over the pair of first flaps and the bag of loose kibbles and secured together so as to form a cruciform configuration with the pair of first flaps, wherein the pair of second flaps overlap and are bonded to one another;
a second tear strip operable to separate the pair of second flaps from one another by tearing so as to provide access to the pair of first flaps; and
a first tear strip operable to separate the pair of first flaps from one another by tearing so as to provide access to the bag of loose kibbles.
